(19) United States
(12) Patent Application Publication
(10) Pub. No.: US 2026/0044440 A1
(43) Pub. Date: Feb. 12, 2026

(54) AUTOMATED RESOURCE ALLOCATION AND DEPENDENCY TRACING FOR TESTING LANE GENERATION

(71) Applicant: Capital One Services, LLC, McLean, VA (US)

(72) Inventors: Matthew Louis NOWAK, Midlothian, VA (US); Mohamed SECK, Aubrey, TX (US); Michael Anthony YOUNG, JR., Henrico, VA (US); Lindsay HELBING, Manakin Sabot, VA (US); Christopher MCDANIEL, Glen Allen, VA (US); Luis DE LUCA, Cumming, GA (US)

(21) Appl. No.: 18/798,498

(22) Filed: Aug. 8, 2024

(51) Int. Cl. G06F 11/36; G06F 9/50; G06F 16/955

(52) U.S. Cl. CPC G06F 11/3698; G06F 9/5027; G06F 16/955

(57) ABSTRACT

Various aspects of the present disclosure generally relate to wireless communication. In some aspects, a testing system may receive a request for testing of a first application. The testing system may identify a testing environment for the first application. The testing system may identify a stored instance of the testing environment. The testing system may instantiate a first testing lane based on the stored instance of the testing environment. The testing system may determine a set of resources or a set of dependencies for testing the first application in the testing environment. The testing system may configure the first testing lane based on the set of resources or the set of dependencies. The testing system may execute a set of tests on the first application using the first testing lane and provide an output identifying a result. Numerous other aspects are described.

### BACKGROUND

A testing environment is a computing environment in which a software application may undergo a set of tests to identify and fix errors in the software application or to benchmark functionality or performance of the software application. The testing environment is configured to correspond to a production environment to which the software application is to be deployed, but the testing environment may be isolated from live users or real data to avoid adverse impacts to operations of the production environment during testing of the software application. Testing environments may include versions of components of the production environment, such as versions of datasets, versions of applications, or versions of physical computing hardware, among other examples, to evaluate how a software application will interact with the components when deployed to the production environment. The testing environment may provide developers with tools to validate code changes, execute automated tests, or configure manual tests.

### SUMMARY

In some implementations, a system for testing lane generation includes one or more memories, and one or more processors, communicatively coupled to the one or more memories, configured to: receive a request for testing of a first application; identify a testing environment for the first application, wherein the testing environment is associated with an instance of a second application; identify a stored instance of the testing environment that satisfies one or more operation criteria; instantiate a testing lane based on the stored instance of the testing environment; determine a set of resources or a set of dependencies for testing the first application in the testing environment, wherein at least one resource or dependency, of the set of resources or the set of dependencies, is associated with the second application; update a set of addresses associated with the set of resources or the set of dependencies based on the testing lane; execute a set of tests on the first application using the testing lane and based on updating the set of addresses; and provide an output identifying a result of executing the set of tests on the first application.

In some implementations, a method for application testing includes receiving, by a testing system, a request for testing of a first application; identifying, by the testing system, a testing environment for the first application, wherein the testing environment is associated with an instance of a second application and a third application; identifying, by the testing system, a stored instance of the testing environment that satisfies one or more operation criteria; instantiating, by the testing system, a first testing lane based on the stored instance of the testing environment and a second testing lane based on the stored instance of the testing environment, wherein the first testing lane is associated with the second application and the second testing lane is associated with the third application; determining, by the testing system, a set of resources or a set of dependencies for testing the first application in the testing environment; configuring, by the testing system, the first testing lane and the second testing lane based on the set of resources or the set of dependencies; executing, by the testing system and based on configuring the first testing lane and the second testing lane, a set of tests on the first application using at least one of the first testing lane or the second testing lane; and providing, by the testing system, an output identifying a result of executing the set of tests on the first application.

In some implementations, a non-transitory computer-readable medium storing a set of instructions includes one or more instructions that, when executed by one or more processors of a system, cause the system to: receive a request for testing of a first application; identify a testing environment for the first application, wherein the testing environment is associated with an instance of a second application; identify a stored instance of the testing environment that satisfies one or more operation criteria; instantiate a testing lane based on the stored instance of the testing environment; configure, using an artificial intelligence model, one or more configuration parameters of the testing lane; execute a set of tests on the first application using the testing lane and based on configuring the testing lane; and provide an output identifying a result of executing the set of tests on the first application.

### BRIEF DESCRIPTION OF THE DRAWINGS

FIGS. 1A-1C are diagrams of an example associated with automated resource allocation and dependency tracing for testing lane generation, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automated resource allocation and dependency tracing for testing lane generation, in accordance with some embodiments of the present disclosure.

FIG. 4 is a flowchart of an example process associated with automated resource allocation and dependency tracing for testing lane generation, in accordance with some embodiments of the present disclosure.

### DETAILED DESCRIPTION

The following detailed description of example implementations refers to the accompanying drawings. The same reference numbers in different drawings may identify the same or similar elements.

A testing environment may be used for testing software applications or other components. The testing environment may provide computing resources, access to physical or virtualized hardware, datasets, applications, or other components with which a software application may interact to enable a determination of the behavior of the software application. The components of the testing environment may have complex linkages and dependencies. For example, a testing environment may include a first dataset that is generated by a first application based on other data from a second dataset and a third dataset, which the first application accesses via a set of network addresses of a physical data repository storing the second dataset and the third dataset.

In complex computing systems, multiple teams of developers may develop multiple applications or application integrations in parallel. Accordingly, a second application or a third application may interact with the first dataset that is being generated by the first application, call an application programming interface (API) of the first application, or use network resources to access the network addresses of the physical data repository in parallel with access by the first application. Accordingly, when a first development team is to test a new feature on a first application, the first development team may tear down an old version of the first application and deploy a new version of the first application. In parallel, a second development team may be testing a second application that integrates with or is affected by the first application. However, the second development team may be unable to test the second application based on the first application having been temporarily torn down or based on instability in a new version of the first application.

As a result, a set of tests executed on the second application may fail, or provide inaccurate results, which may cause a delay in deployment of the second application, or unpredictable behavior when the second application is deployed to a production environment.

Some organizations may organize schedules for use of a testing environment to ensure that conflicts between development teams or parallel development of applications do not result in inaccurate test results. However, scheduled-based use of a testing environment may limit an ability to perform parallel development and testing, which may further delay deployment of applications (or updates thereof), thereby resulting in delayed feature availability or poor performance from older versions of applications remaining in a production environment, while a development team waits for scheduled use of a testing environment.

Some implementations described herein enable automated resource allocation and dependency tracing for testing lane generation. As a result, a testing system may establish parallel testing lanes from a testing environment to permit parallel testing of applications or application integrations. For example, some techniques described herein may allocate resources to a testing lane based on an architecture of a testing environment, an application being tested in the testing environment, and/or a set of components being affected by testing of the application in the testing environment. Based on establishing a testing lane, a testing system may execute a set of tests on an application, provide an output identifying a set of results of the set of tests, and/or automatically deploy an application that passes a set of tests to a production environment. By establishing parallel testing lanes, some techniques described herein may reduce an amount of time to test and deploy software applications, thereby improving feature availability and performance in a production environment. Additionally, or alternatively, by separating testing lanes for different applications or development teams, the techniques described herein may improve security and/or enable satisfaction of data privacy compliance rules.

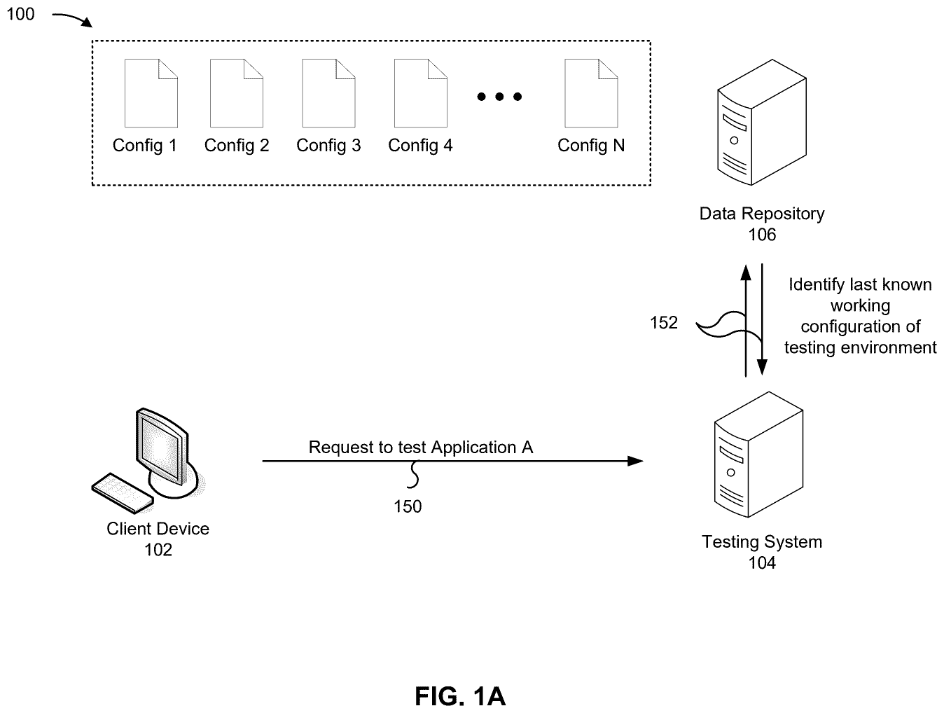

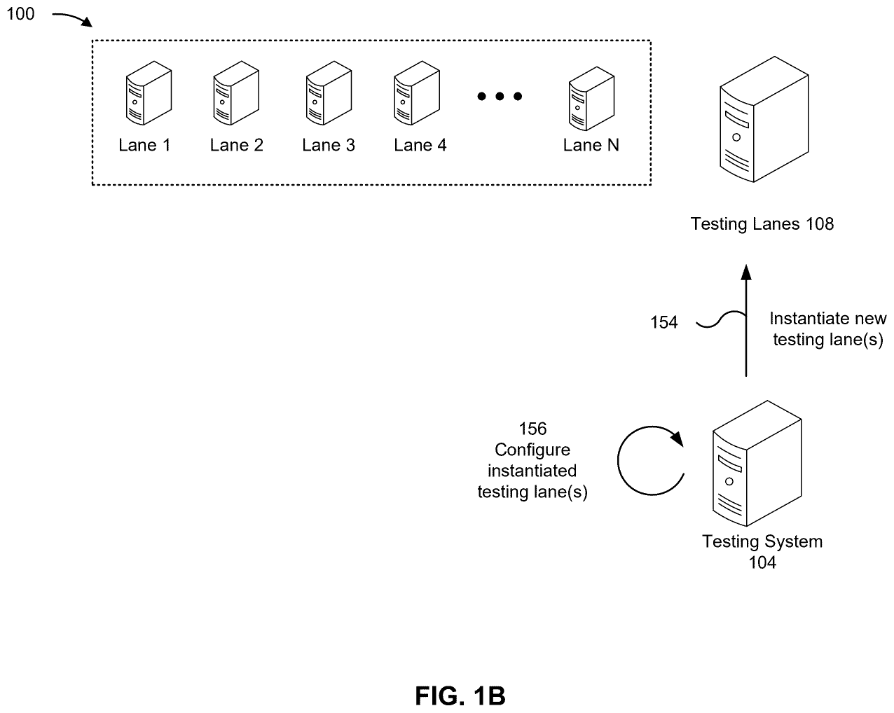

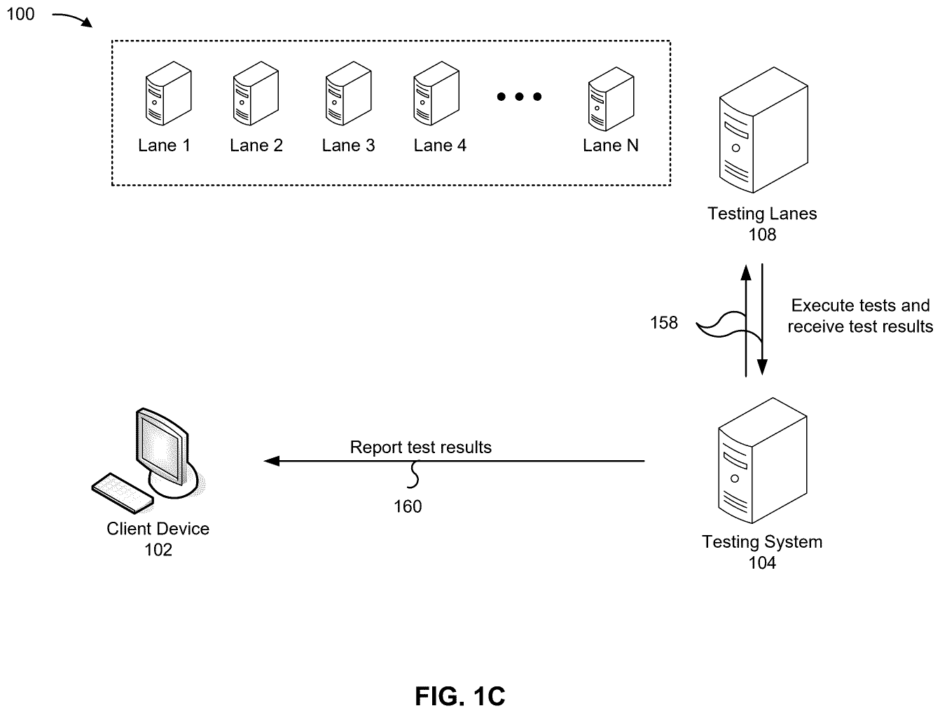

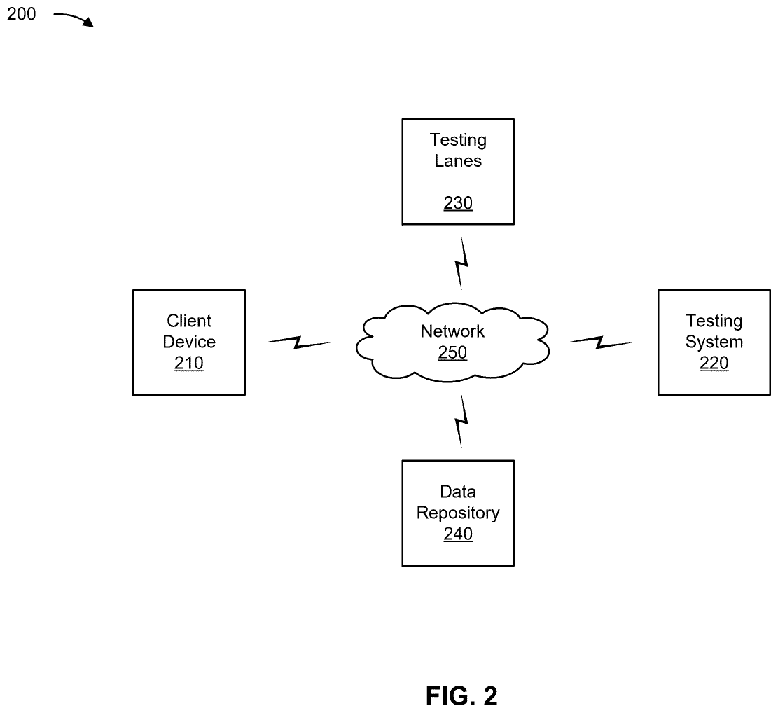

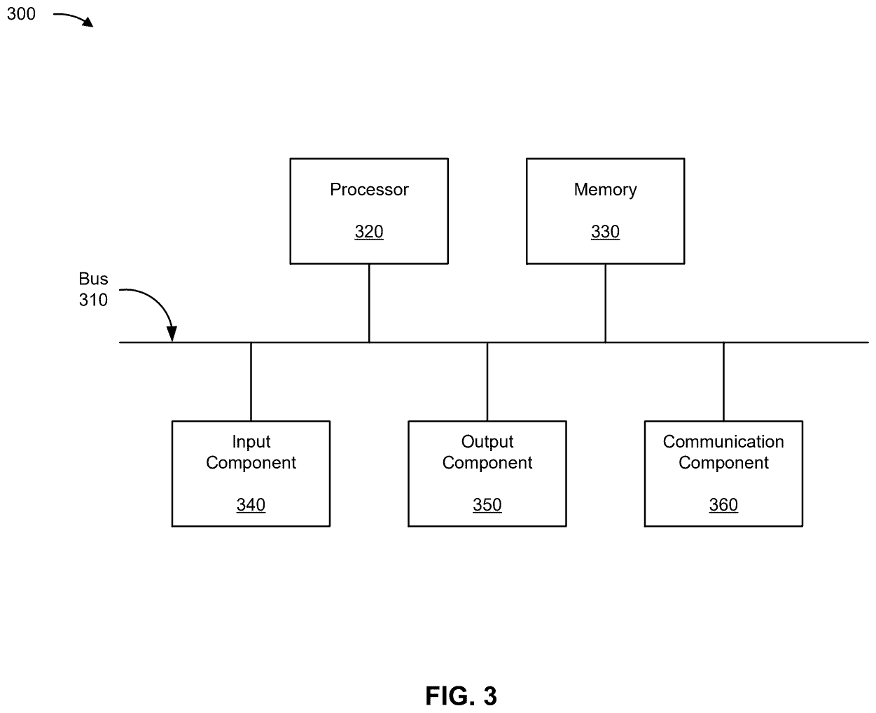

FIGS. 1A-1C are diagrams of an example 100 associated with automated resource allocation and dependency tracing for testing lane generation. As shown in FIGS. 1A-1C, example 100 includes a client device 102, a testing system 104, a data repository 106, and a set of testing lanes 108. These devices are described in more detail in connection with FIGS. 2 and 3.

As further shown in FIG. 1A, and by reference number 150, the testing system 104 may receive a request to test an application. For example, the testing system 104 may receive a request to test an application associated with a first entity (e.g., a first development team). In this case, the application may have one or more dependencies that link the application with one or more other software components, such as one or more other applications associated with one or more second entities (e.g., one or more second development teams). In some implementations, the testing system 104 may receive the request to test the application from the client device 102. For example, when a development team is to test an application (or an integration into an application) for deployment into a production environment, the development team may use the client device 102 to request testing to be performed on the application (or the integration into the application).

As further shown in FIG. 1A, and by reference number 152, the testing system 104 may identify an instance of a testing environment. For example, the testing system 104 may determine a last known working configuration of a testing environment. In this case, the data repository 106 may store a set of configurations or instances of the testing environment and may provide information identifying a configuration or instance of the testing environment that satisfies one or more criteria. The one or more criteria may relate to operation results from execution of tests in the testing environment, such as criteria relating to whether tests were executed successfully, whether components of the testing environment correspond to a current production environment, or whether an instance of the testing environment has previously been used to test the application, among other examples.

As shown in FIG. 1B, and by reference number 154, the testing system 104 may instantiate one or more new testing lanes. For example, the testing system 104 may allocate resources to the testing lanes 108 to establish a testing lane for testing the application. A testing lane may include an on-demand instance of a testing environment with a configuration that is determined based on one or more characteristics of the testing environment, the application to be tested, and/or one or more applications associated with the application to be tested. For example, the testing system 104 may assign a set of computing resources of a cloud computing environment to generate a virtualized software environment that corresponds to a stored instance of the testing environment (e.g., the testing environment at a particular time), for testing the application. In other words, the testing lanes 108 may include copies of an actual test environment's last known working configuration and may be identical to the actual test environment except with respect to a set of configured changes. The set of configured changes may include changes to network addresses or resource locators, removal of resources not linked to execution of tests on the application, and/or addition of resources for execution of the set of tests, as described in more detail herein. As shown by reference number 156, the testing system 104 may configure the one or more instantiated testing lanes. For example, the testing system 104 may configure one or more applications, configure one or more data repositories, and/or configure one or more addresses for an instantiated testing lane. In some implementations, the testing system 104 may configure and/or change a set of addresses. For example, the testing system 104 may update one or more uniform resource locators (URLs), medium access control (MAC) addresses, and/or record locators from a first address associated with a testing environment or production environment to a second address associated with a testing lane. In this case, configuration information of the testing environment (e.g., the last-known-working configuration or a most-recently-working instance of the testing environment) may include information identifying which network addresses are to be updated when generating a testing lane corresponding to the testing environment.

In some implementations, the testing system 104 may determine a chain of dependencies and configure a testing lane based on the chain of dependencies. For example, the testing system 104 may determine one or more datasets that are used by or created by an application, one or more other applications that also use or create the one or more datasets, and/or one or more other applications that use an API or provide an API that is used by the application that is to be tested, among other examples. In this case, the testing system 104 may generate one or more instances of the one or more other applications or the one or more datasets and may update one or more addresses to enable the application to access or be accessed by the one or more other applications or the one or more datasets. In other words, the testing system 104 may determine that an application “A” is to be tested and that, to run a test, an application “B” is to process data from an application “C” and provide the data to the application “A.” Accordingly, the testing system 104 may instantiate instances of the applications “B” and “C” on-demand based on a last known working configuration of the testing environment. In this way, the testing system 104 can ensure testing of the application “A,” even when the applications “B” and “C” are being developed, are altered, or are otherwise inaccessible in a current version of the testing environment.

In some implementations, the testing system 104 may determine a set of resources and configure a testing lane based on the set of resources. For example, the testing system 104 may determine, based on a characteristic of the testing environment, the application that is to be tested, or another application or data repository, one or more ports, processors, switches, peripherals, and/or other computing hardware that is used by, accessed by, uses, or accesses the application that is to be tested (or any other application or dataset with a linkage to the application that is to be tested). In this case, the testing system 104 may generate or assign instances of the computing hardware and/or may update one or more addresses associated with the computing hardware to enable the application to access or be accessed by the computer hardware during execution of one or more tests.

In some implementations, the testing system 104 may use an artificial intelligence (AI) technique to evaluate one or more dependencies, resources, or other linkages. For example, the testing system 104 may use an AI code evaluation tool to parse a codebase of an application and identify the one or more dependencies, resources, or other linkages. Additionally, or alternatively, the testing system 104 may use an AI code evaluation tool to predict a resource utilization of the application and efficiently allocate resources to a testing lane to enable execution of one or more tests on the application based on the predicted resource utilization.

In some implementations, the testing system 104 may configure a plurality of testing lanes of the testing lanes 108. For example, when the testing system 104 identifies a first application and a second application that are affected by execution of a set of tests on a target application, the testing system 104 may generate a first testing lane with the first application for execution of the set of tests on the target application, and a second testing lane with the second application for execution of the set of tests on the target application. In this case, the testing system 104 may configure the first testing lane with a first one or more configuration parameters and the second testing lane with a second one or more configuration parameters. For example, the testing system 104 may apply an AI code evaluation technique to analyze the first application and/or the target application and determine the first one or more configuration parameters, and may apply the AI code evaluation technique to analyze the second application and/or the target application and determine the second one or more configuration parameters. Additionally, or alternatively, the testing system 104 may generate a plurality of testing lanes and execute a plurality of subsets of a set of tests in the plurality of testing lanes (e.g., a first subset of tests in a first testing lane and a second subset of tests in a second testing lane). In this way, the testing system 104 may parallelize testing of an application, thereby reducing an amount of time to test and deploy the application.

In some implementations, the testing system 104 may receive user input (or results of test execution) and may update the one or more configuration parameters for a testing lane. For example, the testing system 104 may receive information identifying an error in executing a test and may update the one or more configuration parameters to resolve the error. In this case, the testing system 104 may re-train an AI model (e.g., an AI code evaluation technique model or another AI model used for configuration of a testing lane) based on updating the one or more configuration parameters.

As shown in FIG. 1C, and by reference number 158, the testing system 104 may execute one or more tests and receive a set of test results. For example, the testing system 104 may cause the one or more tests to be executed on an application in a testing lane and may determine a set of results of executing the one or more tests. In this case, the testing system 104 may identify errors associated with the one or more tests, datasets generated in connection with execution of the one or more tests, computing resource usage associated with execution of the one or more tests, or an amount of time to complete execution of the one or more tests, among other examples. In some implementations, the testing system 104 may transmit an instruction to the testing lanes 108 (e.g., to one or more computing resources associated with the testing lanes 108) to cause the one or more tests to be executed on an application in one or more testing lanes of the testing lanes 108.

In some implementations, the testing system 104 may track usage of a testing lane of the testing lanes 108. For example, the testing system 104 may determine that the one or more tests executed on the application are associated with a particular resource utilization (e.g., a particular energy utilization, a particular processor utilization, a particular amount of time utilizing one or more resources). In this case, the testing system 104 may automatically assign the particular resource utilization to a user associated with the execution of the tests. In other words, the testing system 104 may automatically determine that a user has used a particular amount of testing time that has been allocated for use by the particular user. Additionally, or alternatively, the testing system 104 may automatically execute a transaction for a particular user for the particular resource utilization (and may automatically charge other users for other resource utilizations associated with other tests executed in other testing lanes of the testing lanes 108).

In some implementations, the testing system 104 may pause execution of a set of tests on an application. For example, the testing system 104 may determine that a resource utilization associated with executing the set of tests exceeds a threshold level (e.g., a threshold level that is assigned for a particular user). In this case, the testing system 104 may pause execution of the set of tests and/or may transmit an alert (e.g., to the client device 102) to indicate that execution of the set of tests has been paused. Based on receiving the alert, the client device 102 may transmit a request to restart execution of the set of tests (e.g., an indication that the particular user has authorized usage of additional computing resources above the threshold level).

As further shown in FIG. 1C, and by reference number 160, the testing system 104 may report test results to the client device 102. For example, the testing system 104 may transmit information identifying a set of results of executing the one or more tests. Additionally, or alternatively, the testing system 104 may automatically deploy the application to a production environment based on the test results (e.g., based on the application being determined to pass the one or more tests). Additionally, or alternatively, the testing system 104 may automatically resolve one or more errors determined based on the one or more tests executed on the application. For example, the testing system 104 may use an artificial intelligence (AI) code generation tool to automatically generate program code to resolve an error, add a functionality, or more efficiently perform a computing task in connection with results of the one or more tests executed on the application.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a client device 210, a testing system 220, a set of testing lanes 230, a data repository 240, and a network 250. Devices of environment 200 may interconnect via wired connections, wireless connections, or a combination of wired and wireless connections.

The client device 210 may include one or more devices capable of receiving, generating, storing, processing, and/or providing information associated with testing and development of an application, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The testing system 220 may include one or more devices capable of receiving, generating, storing, processing, providing, and/or routing information associated with instantiation of a testing lane for execution of a set of tests on an application, as described elsewhere herein. The testing system 220 may include a communication device and/or a computing device. For example, the testing system 220 may include a server, such as an application server, a client server, a web server, a database server, a host server, a proxy server, a virtual server (e.g., executing on computing hardware), or a server in a cloud computing system. In some implementations, the testing system 220 may include computing hardware used in a cloud computing environment.

The testing lanes 230 may include one or more devices capable of receiving, generating, storing, processing, providing, and/or routing information associated with providing a testing environment for execution of a set of tests on an application, as described elsewhere herein. The testing lanes 230 may include a communication device and/or a computing device. For example, the testing lanes 230 may include a server, such as an application server, a client server, a web server, a database server, a host server, a proxy server, a virtual server (e.g., executing on computing hardware), or a server in a cloud computing system. In some implementations, the testing lanes 230 may include computing hardware used in a cloud computing environment. For example, a cloud computing environment may provide computing resources for instantiating a plurality of testing lanes 230, such as via a plurality of virtual machines or virtual environments.

The data repository 240 may include one or more devices capable of receiving, generating, storing, processing, and/or providing information associated with generating a testing lane for testing an application, as described elsewhere herein. The data repository 240 may include a communication device and/or a computing device. For example, the data repository 240 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data repository 240 may communicate with one or more other devices of environment 200, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automated resource allocation and dependency tracing for testing lane generation. The device 300 may correspond to client device 210, testing system 220, testing lanes 230, and/or data repository 240. In some implementations, client device 210, testing system 220, testing lanes 230, and/or data repository 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

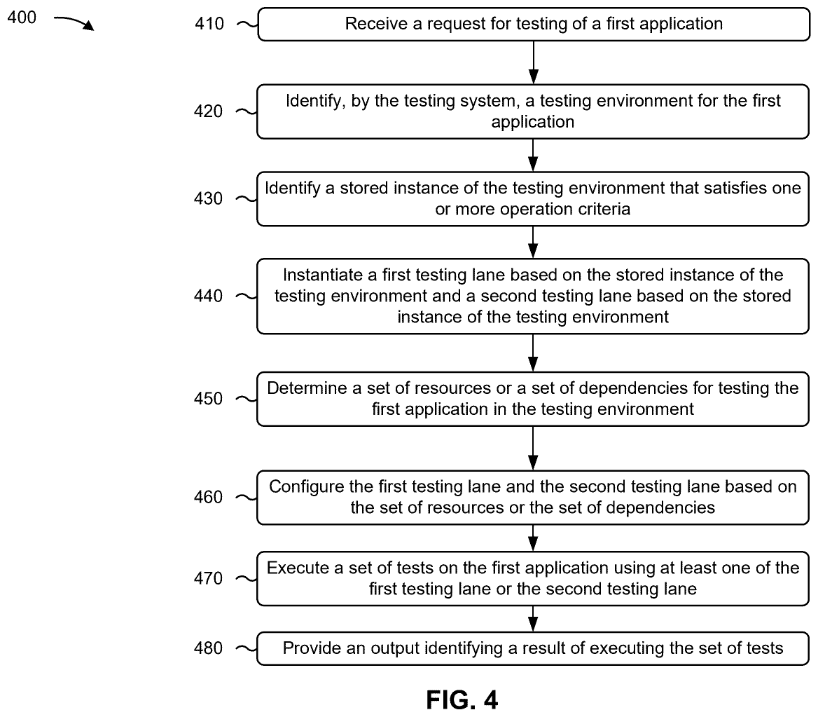

FIG. 4 is a flowchart of an example process 400 associated with automated resource allocation and dependency tracing for testing lane generation. In some implementations, one or more process blocks of FIG. 4 are performed by a testing system (e.g., testing system 220). In some implementations, one or more process blocks of FIG. 4 are performed by another device or a group of devices separate from or including the testing system, such as a client device (e.g., client device 210), a testing lane (e.g., of testing lanes 230), and/or a data repository (e.g., data repository 240). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving a request for testing of a first application (block 410). For example, the testing system 220 (e.g., using processor 320, memory 330, input component 340, and/or communication component 360) may receive a request for testing of a first application, as described above in connection with reference number 150 of FIG. 1A. As an example, the testing system 220 may receive information identifying an application “A” that is to be tested in a testing environment.

As further shown in FIG. 4, process 400 may include identifying a testing environment for the first application, wherein the testing environment is associated with an instance of a second application and a third application (block 420). For example, the testing system 220 (e.g., using processor 320 and/or memory 330) may identify a testing environment for the first application, wherein the testing environment is associated with an instance of a second application and a third application, as described above in connection with reference number 152 of FIG. 1A. As an example, the testing system 220 may identify the testing environment that corresponds to a production environment to which application “A” is to be deployed.

As further shown in FIG. 4, process 400 may include identifying a stored instance of the testing environment that satisfies one or more operation criteria (block 430). For example, the testing system 220 (e.g., using processor 320 and/or memory 330) may identify a stored instance of the testing environment that satisfies one or more operation criteria, as described above in connection with reference number 152 of FIG. 1A. As an example, the testing system 220 may identify a last known working configuration of a testing environment that corresponds to a production environment to which application “A” is to be deployed.

As further shown in FIG. 4, process 400 may include instantiating a first testing lane based on the stored instance of the testing environment and a second testing lane based on the stored instance of the testing environment, wherein the first testing lane is associated with the second application and the second testing lane is associated with the third application (block 440). For example, the testing system 220 (e.g., using processor 320 and/or memory 330) may instantiate a first testing lane based on the stored instance of the testing environment and a second testing lane based on the stored instance of the testing environment, wherein the first testing lane is associated with the second application and the second testing lane is associated with the third application, as described above in connection with reference number 154 of FIG. 1B. As an example, the testing system 220 may assign resources to a testing lane 230 to use for executing tests on the application “A.”As further shown in FIG. 4, process 400 may include determining a set of resources or a set of dependencies for testing the first application in the testing environment (block 450). For example, the testing system 220 (e.g., using processor 320 and/or memory 330) may determine a set of resources or a set of dependencies for testing the first application in the testing environment, as described above in connection with reference number 156 of FIG. 1B. As an example, the testing system 220 may determine which computing resources are to be allocated for the testing lane and/or a dependency chain for applications that may be affected by or may affect execution of the set of tests on the application “A.”As further shown in FIG. 4, process 400 may include configuring the first testing lane and the second testing lane based on the set of resources or the set of dependencies (block 460). For example, the testing system 220 (e.g., using processor 320 and/or memory 330) may configure the first testing lane and the second testing lane based on the set of resources or the set of dependencies, as described above in connection with reference number 156 of FIG. 1B. As an example, the testing system 220 may update one or more resource addresses in the application “A” from a first set of addresses in the testing environment or a production environment to a second set of addresses that are specific to a testing lane.

As further shown in FIG. 4, process 400 may include executing, based on configuring the first testing lane and the second testing lane, a set of tests on the first application using at least one of the first testing lane or the second testing lane (block 470). For example, the testing system 220 (e.g., using processor 320 and/or memory 330) may execute, based on configuring the first testing lane and the second testing lane, a set of tests on the first application using at least one of the first testing lane or the second testing lane, as described above in connection with reference number 158 of FIG. 1C. As an example, the testing system 220 may input a data set of test data into the application “A” and determine a set of results of inputting the test data into the application “A.”

As further shown in FIG. 4, process 400 may include providing an output identifying a result of executing the set of tests on the first application (block 480). For example, the testing system 220 (e.g., using processor 320 and/or memory 330) may provide an output identifying a result of executing the set of tests on the first application, as described above in connection with reference number 160 of FIG. 1C. As an example, the testing system 220 may transmit information identifying one or more results of one or more tests executed on the application “A” using a testing lane.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c”is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for testing lane generation, the system comprising:
one or more memories; and
one or more processors, communicatively coupled to the one or more memories, configured to:
receive a request for testing of a first application;
identify a testing environment for the first application,
wherein the testing environment is associated with an instance of a second application;
identify a stored instance of the testing environment that satisfies one or more operation criteria;
instantiate a testing lane based on the stored instance of the testing environment;
determine a set of resources or a set of dependencies for testing the first application in the testing environment,
wherein at least one resource or dependency, of the set of resources or the set of dependencies, is associated with the second application;
update a set of addresses associated with the set of resources or the set of dependencies based on the testing lane;
execute a set of tests on the first application using the testing lane and based on updating the set of addresses; and
provide an output identifying a result of executing the set of tests on the first application.

2. The system of claim 1, wherein the one or more processors, to instantiate the testing lane, are configured to:
allocate a set of resources or a computing environment to the testing lane based on one or more characteristics of the testing environment.

3. The system of claim 1, wherein the one or more processors, to determine the set of resources or the set of dependencies, are configured to:
identify a set of uniform resource locator (URL) addresses associated with the testing environment; and
wherein the one or more processors, to update the set of addresses, are configured to:
change the set of URL addresses associated with the testing environment to a set of updated URL addresses associated with the testing lane.

4. The system of claim 1, wherein the one or more processors, to determine the set of resources or the set of dependencies are configured to:
determine a chain of dependencies between the first application and the second application; and
generate one or more instances of the second application based on the chain of dependencies between the first application and the second application.

5. The system of claim 1, wherein the one or more processors, to identify the stored instance of the testing environment, are to:
evaluate a set of operation results of the stored instance of the testing environment to determine that the instance of the testing environment is a most-recently-working instance of the testing environment; and
select the stored instance of the testing environment based on evaluating the set of operation results.

6. The system of claim 1, wherein the one or more processors are further configured to:
store information identifying a resource utilization associated with the execution of the set of tests in the testing lane; and
output a report identifying the resource utilization associated with the execution of the set of tests in the testing lane.

7. The system of claim 6, wherein the one or more processors are further configured to:
automatically execute a transaction based on the resource utilization associated with the execution of the set of tests in the testing lane.

8. The system of claim 6, wherein the one or more processors are further configured to:
determine that the resource utilization exceeds a threshold level;
pause the execution of the set of tests based on determining that the resource utilization exceeds a threshold level; and
transmit an alert based on pausing the execution of the set of tests.

9. A method for application testing, comprising:
receiving, by a testing system, a request for testing of a first application;
identifying, by the testing system, a testing environment for the first application,
wherein the testing environment is associated with an instance of a second application and a third application;
identifying, by the testing system, a stored instance of the testing environment that satisfies one or more operation criteria;
instantiating, by the testing system, a first testing lane based on the stored instance of the testing environment and a second testing lane based on the stored instance of the testing environment,
wherein the first testing lane is associated with the second application and the second testing lane is associated with the third application;
determining, by the testing system, a set of resources or a set of dependencies for testing the first application in the testing environment;
configuring, by the testing system, the first testing lane and the second testing lane based on the set of resources or the set of dependencies;
executing, by the testing system and based on configuring the first testing lane and the second testing lane, a set of tests on the first application using at least one of the first testing lane or the second testing lane; and
providing, by the testing system, an output identifying a result of executing the set of tests on the first application.

10. The method of claim 9, wherein the first testing lane is associated with a first one or more configuration parameters and the second testing lane is associated with a second one or more configuration parameters.

11. The method of claim 10, further comprising:
determining the first one or more configuration parameters using an artificial intelligence model applied to the second application; and
determining the second one or more configuration parameters using the artificial intelligence model applied to the third application.

12. The method of claim 11, further comprising:
identifying one or more updates to the first one or more configuration parameters or the second one or more configuration parameters; and
re-training the artificial intelligence model based on the one or more updates.

13. A non-transitory computer-readable medium storing a set of instructions, the set of instructions comprising:
one or more instructions that, when executed by one or more processors of a system, cause the system to:
receive a request for testing of a first application;
identify a testing environment for the first application,
wherein the testing environment is associated with an instance of a second application;
identify a stored instance of the testing environment that satisfies one or more operation criteria;
instantiate a testing lane based on the stored instance of the testing environment;
configure, using an artificial intelligence model, one or more configuration parameters of the testing lane;
execute a set of tests on the first application using the testing lane and based on configuring the testing lane; and
provide an output identifying a result of executing the set of tests on the first application.

14. The non-transitory computer-readable medium of claim 13, wherein the one or more instructions, that cause the system to instantiate the testing lane, cause the system to:
allocate a set of resources or a computing environment to the testing lane based on one or more characteristics of the testing environment.

15. The non-transitory computer-readable medium of claim 13, wherein the one or more instructions, when executed by the one or more processors, cause the system to:
identify a set of addresses associated with the testing environment; and
change the set of addresses associated with the testing environment to a set of updated addresses associated with the testing lane.

16. The non-transitory computer-readable medium of claim 13, wherein the one or more instructions, that cause the system to determine the set of resources or the set of dependencies, cause the system to:
determine a chain of dependencies between the first application and the second application; and
generate one or more instances of the second application based on the chain of dependencies between the first application and the second application.

17. The non-transitory computer-readable medium of claim 13, wherein the one or more instructions, that cause the system to identify the stored instance of the testing environment, cause the system to:
evaluate a set of operation results of the stored instance of the testing environment to determine that the instance of the testing environment is a most-recent-working instance of the testing environment; and
select the stored instance of the testing environment based on evaluating the set of operation results.

18. The non-transitory computer-readable medium of claim 13, wherein the one or more instructions further cause the system to:
identify one or more updates to the one or more configuration parameters; and
re-train the artificial intelligence model based on the one or more updates to the one or more configuration parameters.

19. The non-transitory computer-readable medium of claim 13, wherein the testing lane is a first testing lane; and wherein the one or more processors are further configured to:
instantiate a second testing lane associated with a third application; and
wherein the one or more instructions, that cause the system to execute the set of tests, cause the system to:
execute a first subset of tests using the first testing lane and a second subset of tests using the second testing lane.

20. The non-transitory computer-readable medium of claim 19, wherein the first testing lane is associated with a first one or more configuration parameters and the second testing lane is associated with a second one or more configuration parameters.
